(19) United States
(12) Patent Application Publication
(10) Pub. No.: US 2005/0140168 A1
(43) Pub. Date: Jun. 30, 2005

(54) Door trim panel assembly having integrated soft-touch aesthetic feature and method of manufacturing same

(76) Inventor: David M. Emerling, West Bloomfield, MI (US)

Correspondence Address: LEAR CORPORATION, BLISS MCGLYNN, P.C., 2075 WEST BIG BEAVER ROAD, SUITE 600, TROY, MI, 48084, US

(21) Appl. No.: 10/749,161

(22) Filed: Dec. 30, 2003

(51) Int. Cl. B60J 5/00

(52) U.S. Cl. 296/146.7

(57) ABSTRACT

The present invention relates to a method of manufacturing a door trim panel assembly having an integrated soft-touch area including actuating a core within a mold cavity so as to partition at least one area of the mold cavity, to prevent a first molten thermoplastic material from completely filling the mold cavity. A first molten thermoplastic material having a predetermined density is then injected into a mold cavity so as to fill the mold cavity thereby forming a structural element. The core is then retracted within the mold cavity to provide at least one secondary void within the mold cavity. A second molten thermoplastic material having a density less than the predetermined density of the first molten thermoplastic material is then injected into said secondary void of the mold cavity to form at least one soft-touch area bonded to and adjacent at least a portion of the structural element.

### BACKGROUND OF THE INVENTION

1. Field of the Invention

The present invention relates, generally, to a door trim panel assembly for automotive vehicle interiors. More specifically, the present invention relates to a door trim panel assembly having an integrated soft-touch feature and method of manufacturing same.

2. Description of the Related Art

Interior trim components for automobiles commonly include a trim panel mounted to a vehicle door. Typically, automotive door trim panels often have designated cushioned areas in the armrest or bolster area to impart a tactile, comfortable area commonly referred to as a “soft-touch area.” The soft-touch area of a door trim panel includes components manufactured independent from the door trim panel per se and subsequently assembled thereto.

Traditionally, these components include a plurality of pre-formed components such as a rigid substrate, foam intermediate layer and coverstock, among others. The rigid substrate is often constructed from a polymer and manufactured via an injection molding process. In this case, a mold cavity must be tooled to conform to the predetermined dimensions of the soft-touch area. The intermediate layer is typically a pre-formed flexible-foam or elastomeric pad of varying thickness. The intermediate layer may be purchased in sheet form and subsequently trimmed to correspond to the shape of the rigid substrate. While neither of these pre-formed components is visible from the vehicle interior, they still require assembly, manufacture, and handling separate from actually assembling the soft-touch area, resulting in a significant cost factor associated with this effort.

The top surface of the soft-touch area is commonly referred to as “coverstock.” The coverstock presents a “class-A” surface that is visible from the vehicle interior when installed and a “class-B” surface that contacts the foam intermediate layer. The coverstock may be constructed from any number of materials to provide a durable yet aesthetic surface layer for the soft-touch area. By way of example, coverstock materials such as leather, cloth, or high-grade polymers, which often impart a textured class-A surface simulating the grain of leather, may be employed to cover the soft-touch area. Because the coverstock must be durable and provide an aesthetically pleasing class-A surface, it is often the most costly component of the door trim panel when compared to the rigid substrate and foam intermediate layer. Further, the coverstock requires secondary handling to trim the material to correspond to the predetermined shape of the soft-touch area.

In addition to the cost associated with manufacturing the pre-formed components of the soft-touch area of a door trim panel, there are additional cost factors associated with assembling these components to a door trim panel. More specifically, the armrest often requires extensive labor to stretch the coverstock, sew and/or glue the components together. The additional handling and assembly efforts required to assemble a door trim panel armrest or bolster having a soft-touch area may also give rise to defective or substandard assembly, resulting from improper fitting of the components or misalignment during the sewing and/or gluing process. In any event, the secondary handling and assembly as well as the production of substandard products result in increased costs to produce a door trim panel assembly with a soft-touch area.

There are several different known processes that may be employed to manufacture a door trim panel component having an integrated soft-touch aesthetic feature such as a bolster and/or armrest. By way of example, processes involving low pressure molding, structural reaction injection molding, and vacuum forming have all been employed to reduce the costs associated with assembling the substrate, intermediate foam layer and coverstock to produce a door trim panel assembly having an integrated soft-touch aesthetic feature. These processes involve securing the coverstock to the substrate and subsequently placing a foam intermediate layer therebetween.

However, each of the above-identified processes require assembly of the coverstock, intermediate layer, and substrate which also requires additional, secondary handling. More importantly, each of the above-identified processes employ a coverstock which is associated with the higher part cost, and increased assembly and secondary handling to manufacture a door trim panel having an integrated soft-touch aesthetic feature. Furthermore, each of the above-identified processes may result in the production of a door trim panel having and irregular/misshapen soft-touch area.

While the door trim panels having an integrated soft-touch area of the type known in the related art have generally worked for their intended purposes, there remains a need in the related art to reduce the number of steps required to manufacture a vehicle door trim panel assembly incorporating a soft-touch area. Further, there remains a need in the art to reduce the costs associated with manufacturing a vehicle door trim panel assembly incorporating a soft-touch area. In addition, there remains a need for a vehicle door trim panel assembly that includes an integrated soft-touch area having improved quality. Finally, there remains a need in the art for a vehicle door trim panel assembly that provides a consistent, desirable, class-A surface that is aesthetically pleasing.

### SUMMARY OF THE INVENTION

The present invention overcomes the disadvantages in the related art in door trim panels for vehicles and generally fulfills a need in the art for a method of manufacturing a door trim panel assembly having an integrated soft-touch area for improved aesthetic and ergonomic door trim panel quality. To this end, the method of the present invention includes actuating a core within a mold cavity so as to partition at least one area of the mold cavity to prevent a first molten thermoplastic material from completely filling the mold cavity. A first molten thermoplastic material having a predetermined density is then injected into a mold cavity so as to fill the mold cavity thereby forming a structural element. The core is then retracted from within the mold cavity to provide at least one secondary void within the mold cavity. A second molten thermoplastic material having a density less than the predetermined density of the first molten thermoplastic material is then injected into said secondary void of the mold cavity to form at least one soft-touch area bonded to and adjacent at least a portion of the structural element.

Accordingly, one advantage of the present invention is that it provides an integrated soft-touch area while a door trim panel is formed in a mold and thereby reduces the steps necessary to manufacture the vehicle door trim panel assembly.

Another advantage of the present invention is that it provides an integrated soft-touch area during manufacture of the door trim panel assembly that eliminates quality issues relating to positive alignment during later assembly of a soft-touch area.

Another advantage of the present invention is that it provides a monolithic soft-touch area to reduce cushion variation within the soft-touch area for improved aesthetic quality of the vehicle interior.

Still another advantage of the present invention is that it provides a door trim panel assembly having a soft-touch feature that is co-molded with a trim panel component that simplifies the manufacturing process, thereby reducing the costs associated therewith.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a fragmentary environmental view of a vehicle including a door trim panel assembly having an integrated soft-touch aesthetic feature of the present invention;

FIG. 2A is a perspective view illustrating the molding process employed to manufacture a door trim panel assembly having an integrated soft-touch feature of the present invention;

FIG. 2B is a perspective view of the mold with the door trim panel assembly receiving an integrated soft-touch feature of the present invention shown in phantom;

FIG. 2C is a perspective view of the mold and door trim panel assembly having an integrated soft-touch feature of the present invention; and

FIG. 3 is a cross-sectional view of a component of a door trim panel having an integrated soft-touch aesthetic feature of the present invention.

### DETAILED DESCRIPTION OF THE INVENTION

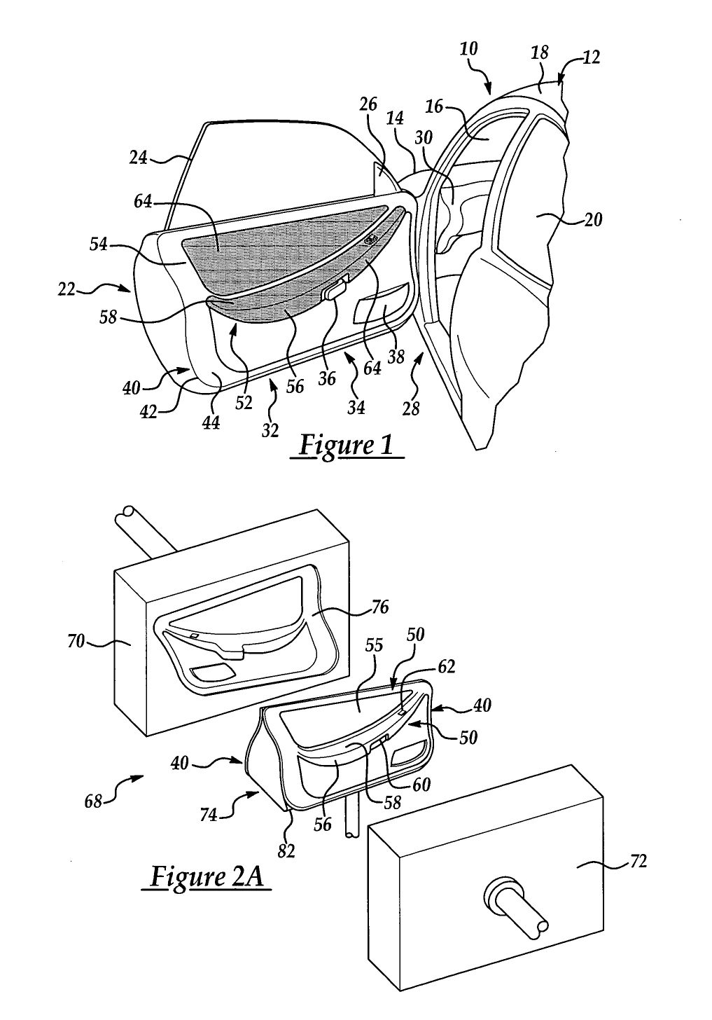

A vehicle that employs the door trim panel assembly of the present invention is generally indicated at 10 in FIG. 1, where like numbers are used to designate like structure throughout the figures. The vehicle 10 includes a vehicle body generally indicated at 12, having a hood 14, windshield 16, roof 18, and side window 20. The vehicle 10 further includes a vehicle door, generally indicated at 22. The vehicle door 22 is adapted to be pivotally mounted to the vehicle body 12 and includes components such as a window 24 and a side mirror panel 26 for covering the side rear view mirror mounts (not shown). The vehicle 10 further includes an interior generally indicated at 28. The interior 28 includes a plurality of trim panels, such as a dashboard 30, that provide an aesthetic and ergonomic environment for the vehicle occupant. However, those having ordinary skill in the art will appreciate that the interior 28 of a vehicle 10 includes components such as seats, a center console, steering wheel as well as other components not illustrated but generally known in the art.

Another trim panel employed within the interior 28 of a vehicle 10 is the modular door trim panel assembly of the present invention which is generally indicated at 32. As illustrated in FIG. 1, the trim panel assembly 32 is mounted to a driver's side door 22. However, those having ordinary skill in the art will appreciate that it may be mounted to any vehicle door. By way of example, the trim panel assembly 32 of the present invention may be mounted to a passenger side door or a hatchback door. Further, the door trim panel assembly 32 may also be molded to any predetermined shape to accommodate adjacent components of the vehicle 10, such as the window 24 or side mirror panel 26.

Referring to FIG. 1, the door trim panel assembly 32 of the present invention includes a plurality of trim panel components generally indicated at 34, each having a surface that is visible from the interior 28 of a vehicle 10. As illustrated throughout the figures, the trim panel components 34 of the trim panel assembly 32, include a door latch assembly 36 to facilitate ingress and egress to and from the vehicle interior 28, a map pocket 38 to retain various articles such as maps, compact discs and other articles, and a window control 39 to facilitate movement of the window 24 of the vehicle door 22. Those having ordinary skill in the art will appreciate that the modular door trim panel assembly 32 of the present invention may include any number of other components such as a speaker cover, cup holder, etc as well as fewer components, depending on the styling of the interior 28 of a vehicle 10.

As illustrated in the figures, the door trim panel assembly 32 includes a substrate generally indicated at 40. The substrate 40 provides a surface upon which the trim panel components 34 may be mounted. The substrate 40 includes a first side 42 defining a class-A surface 44 that is visible from the interior 28 of an automotive vehicle 10 and a second side 46 that is opposite the first side 42 and that defines a class-B surface 48 adjacent the vehicle door 22. The class-A surface 44 may incorporate a pattern or texture, such as the grain of leather, to improve the aesthetic quality of the vehicle interior 28.

The door trim panel assembly 32 of the present invention further includes a structural element, generally indicated at 50, that accommodates additional trim panel components. For example, the door trim panel assembly 32 includes an armrest generally indicated at 52, and a predetermined surface 54 that is visible from the interior 28 of a vehicle 10. The armrest 52 is defined by a plurality of sidewalls 56, 58 having a shape that corresponds to the designated style and area of a particular vehicle interior 28, while the predetermined surface 54 defines a bolster area 55. Those having ordinary skill in the art will appreciate that the sidewalls 56, 58 may include any predetermined shape to compliment the aesthetic features within the interior 28 of a vehicle 10. By way of example, the armrest 52 shown in FIG. 1 includes elongated and arcuate sidewalls 56, 58 for improved aesthetic and ergonomic quality of the interior 28 of a vehicle 10. The sidewalls 56, 58 also include a recess 60 to receive the door latch assembly 36 and an aperture 62 to receive the window control 40. Those having ordinary skill in the art will appreciate that the sidewalls 56, 58 may include any number of recesses 60 or apertures 62 to accommodate other trim panel components to improve the aesthetic and/or ergonomic quality of the interior 28 of a vehicle 10.

Further, the armrest component 52 and the bolster component 54 may also include a soft-touch area 64 bonded to and formed adjacent at least a portion of an underlying structural element 50. A generic representation of a soft-touch area 64 bonded to and formed adjacent at least a portion of the structural element 50 is shown in FIG. 3. Specifically, the soft-touch area 64 is bonded to and formed adjacent the structural element 50 of either the armrest 52 or the bolster 54. The soft-touch area 64 of the door trim panel assembly 32 includes a class-A surface 66 that not only eliminates the need for a coverstock material, but also eliminates the need for an intermediate layer as well, thereby reducing the likelihood of deformation or an otherwise irregular cushion-like feel as a result of a substandard intermediate layer and thereby improve the aesthetic quality of the vehicle interior 28. Referring to FIG. 1, a soft-touch area 64 is bonded to the sidewall 56 of the armrest 52 including the door latch assembly 36 as well as the sidewall 58 including the window control 40. However, those having ordinary skill in the art will appreciate that the soft-touch area 64 may be employed anywhere along the sidewalls 56, 58 of the armrest so as to be visible from the interior of a vehicle and may present any color or pattern.

As noted above, armrest 52 and bolster 54 components of the door trim panel assembly 32 of the present invention are formed via an injection molding process. In this way, the structural elements 50 of the components 52, 54 are essentially co-molded with the soft forming elements of the soft-touch area 64 while the door trim panel substrate 40 is at least partially formed in a mold cavity to reduce the costs associated with manufacturing a component of the door trim panel assembly 32. Generally speaking, the manner in which the structural element 50 receives the soft-touch area 64 streamlines the manufacturing of a door trim panel assembly 32 by eliminating the need for a coverstock and intermediate cushion layer, as well as other secondary handling processes.

The method of the present invention includes the steps of injecting a first molten thermoplastic material having a predetermined density into a mold cavity having an actuated core. When actuated, the core partitions a portion of the mold cavity so as to prevent the first thermoplastic material from completely filling the mold cavity. The first thermoplastic material may include any rigid forming material suitable for use in an injection mold. By way of example the material employed may include nylon, polypropylene, acrylonitrile butadiene styrene (ABS), polyvinyl chloride (PVC) or thermoplastic olefin (TPO) or other rigid forming material.

The first molten thermoplastic material forms a structural element 50 in the mold cavity, defining a component 52, 54 of the door trim panel assembly 32. This structural element 50 may correspond either to the armrest component 52 or the bolster component 54. In either event, upon the lapse of a predetermined amount of time that is specific to the material and mold process conditions, the core is retracted to define a secondary void within the mold cavity. A second molten thermoplastic material is then injected into the secondary void of the mold cavity while the structural element 50 remains tacky. The second molten thermoplastic material includes a density less than that of the first molten thermoplastic material and is bonded to the structural element 50 within the mold cavity. Thus, the second molten thermoplastic material has a softer, more tactile and comfortable feel once it has solidified and cooled than that of the first molten thermoplastic material. Those having ordinary skill in the art will appreciate that any material adapted for use in an injection mold that provides the desired soft-touch feel may be employed. Specifically, the second thermoplastic material imparts a soft-touch area 64 that is bonded to and adjacent at least a portion of the structural element 50.

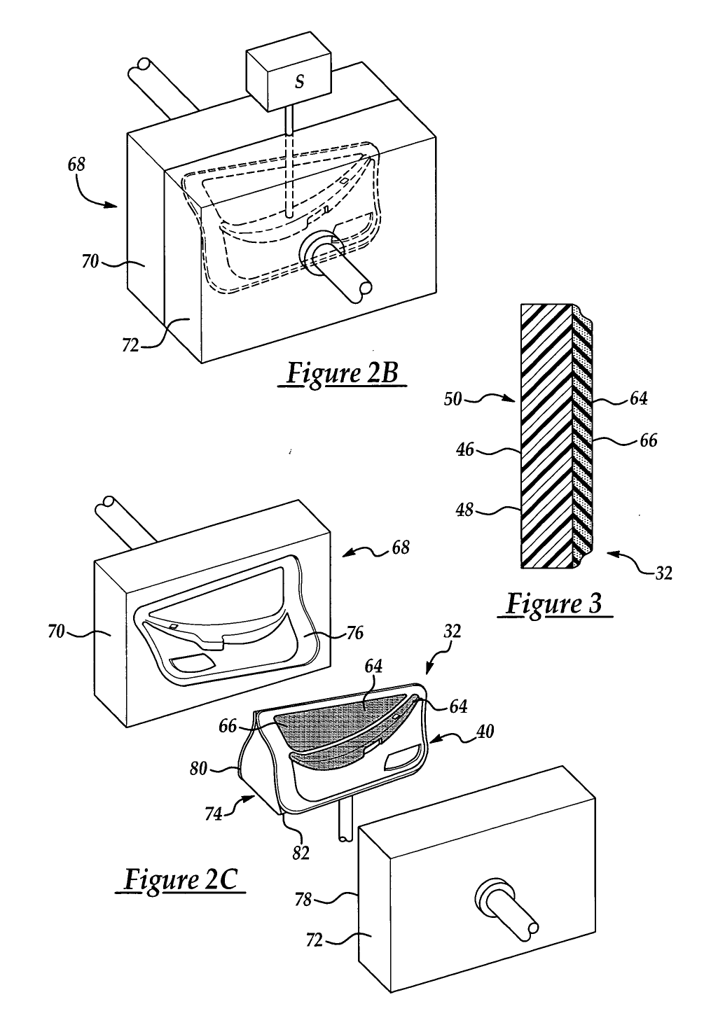

Another method to manufacture a component of the door trim panel assembly is illustrated in FIGS. 2A-2C. This method involves providing a mold, generally indicated at 68, having a first and second die halves 70, 72 and a core, generally indicated at 74, moveably supported relative to the die halves 70, 72. This method employs the same co-molded methodology as above-identified. The core 74 is disposed between the first and second die halves 70, 72 to define a first and second mold cavity 76, 78. A first molten thermoplastic material having a predetermined density is injected into the first mold cavity 76 thereby forming a structural element 50. Again, the structural element 50 formed in the first mold cavity 76 may define either the armrest component 52 or the bolster component 54 and the first molten thermoplastic material has the same characteristics as discussed above.

Following a predetermined lapse of time to permit the structural element 50 to partially cure within the first mold cavity 76, the core 74 is moved relative to the first and second die halves 70, 72 to define a second mold cavity 78. In the preferred embodiment illustrated here, the core 74 is moved in a rotating manner to form the second mold cavity 78 and a second molten thermoplastic material, having a density less that the predetermined density of the first thermoplastic material, is injected therein from a source (S). As noted above, the second molten thermoplastic material has a softer, more tactile and comfortable feel once it has solidified and cooled than that of the first molten thermoplastic material. The second injected molten thermoplastic material forms at least one soft-touch area 64 that is bonded to and disposed adjacent at least a portion of the structural element 50 of the formed component.

As illustrated in FIGS. 3A-3C, the core 74 includes a first surface 80 and a second surface 82 opposite the first surface 80. The first and second surfaces 80, 82 of the core 74 are virtually identical to provide efficient manufacture of door trim panel assembly 32. Specifically, while the second molten thermoplastic material is injected into the second mold cavity 78, the first molten thermoplastic material is injected relative to the opposing core surface in the first mold cavity 76. However, those having ordinary skill in the art will appreciate that the core 74 need not include two surfaces 80, 82 to employ the above-described method.

The present invention reduces the steps necessary to manufacture a vehicle door trim panel assembly 32 having a soft-touch area 64 by eliminating the need for a coverstock. Further, the present invention bonds the soft-touch area 64 to the door trim panel component 52, 54 while in a mold 68, thereby eliminating quality issues relating to positive alignment during later assembly of a soft-touch area 64. Still further, the soft-touch area 64 is injected onto the door trim panel component 52, 54 to provide a uniform feel, thereby reducing cushion variation within the soft-touch area 64 and eliminating the need for an intermediate foam layer to impart a soft-touch area 64.

The present invention has been described in an illustrative manner. It is to be understood that the terminology that has been used is intended to be in the nature of words of description rather than of limitation. Many modifications and variations of the present invention are possible in light of the above teachings. Therefore, within the scope of the appended claims, the present invention may be practiced other than as specifically described.

1. A method of manufacturing a component of a door trim panel assembly for the interior of a vehicle, said method comprising the steps of:
actuating a core within a mold cavity so as to partition at least one area of said mold cavity to prevent a first molten thermoplastic material from completely filling said mold cavity;
injecting the first molten thermoplastic material having a predetermined density into a mold cavity so as to fill said mold cavity thereby forming a structural element;
retracting the core within the mold cavity to provide at least one secondary void within said mold cavity; and
injecting a second molten thermoplastic material having a density less than the predetermined density of said first molten thermoplastic material into said secondary void of said mold cavity to form at least one soft-touch area bonded to and adjacent at least a portion of said structural element.

2. The method as set forth in claim 1 wherein the step of retracting the core within the mold cavity further includes the step of permitting a predetermined lapse of time prior to permit said structural element to partially cure prior to retracting said retractable core.

3. The method as set forth in claim 1 wherein said step of injecting a first thermoplastic material further includes the step of defining a substrate having a plurality of sidewalls that serve as the structural element for an armrest, said second thermoplastic material bonded to and adjacent at least a portion of at least one of said sidewalls to define a soft-touch area on said armrest.

4. The method as set forth in claim 1 wherein said step of injecting a first thermoplastic material further includes the step of defining a substrate that serves as the structural element for a bolster area, said second thermoplastic material bonded to and adjacent at least a portion of said bolster area to define a soft-touch area on said substrate.

5. The method as set forth in claim 1 wherein the step of injecting a second molten thermoplastic material further includes injecting a thermoplastic material having different color than the color of said first molten thermoplastic material.

6. A method of manufacturing a component of a door trim panel assembly for the interior of a vehicle, said method comprising the steps of:
providing a mold having first and second die halves and a core moveably supported relative to said die halves and disposed therebetween to define a first and second mold cavity between said moveable core and said first and second die halves;
injecting said first molten thermoplastic material having a predetermined density into said first mold cavity so as to fill said first mold cavity thereby forming a structural element;
moving a core relative to said first and second die halves to define said second mold cavity; and
injecting a second molten thermoplastic material having a density less than the predetermined density of said first molten thermoplastic material into said second mold cavity thereby forming at least one soft-touch area bonded to and adjacent at least a portion of said structural element of said component.

7. The method as set forth in claim 6 wherein the step of moving said core to define said second mold cavity further includes the step of permitting a predetermined lapse of time prior injecting a second molten thermoplastic material to permit said structural element to partially cure.

8. The method as set forth in claim 6 wherein said step of injecting a first thermoplastic material further includes the step of defining a substrate having a plurality of sidewalls that serve as the structural element for an armrest, said second thermoplastic material bonded to and adjacent at least a portion of at least one of said sidewalls to define a soft-touch area on said armrest.

9. The method as set forth in claim 6 wherein said step of injecting a first thermoplastic material further includes the step of defining a substrate that serves as the structural element for a bolster area, said second thermoplastic material bonded to and adjacent at least a portion of said bolster area to define a soft-touch area on said substrate.

10. The method as set forth in claim 1 wherein the step of injecting a second molten thermoplastic material further includes injecting a thermoplastic material having different color than the color of said first molten thermoplastic material.

11. A component of a door trim panel assembly for the interior of a vehicle, said component comprising:
a structural element formed from the injection of a first molten thermoplastic material having a predetermined density into a mold cavity; and
a soft touch area bonded to and adjacent at least a portion of said structural element, said soft-touch area formed from the injecting a second molten thermoplastic material having a density less than the predetermined density of the first molten thermoplastic material into a secondary void of the mold cavity.

12. The component of a door trim panel assembly as set forth in claim 11 wherein said structural element defines a substrate having a plurality of sidewalls that defines an armrest of said door trim panel assembly.

13. The component of a door trim panel assembly as set forth in claim 12 wherein said soft-touch area is bonded to and formed adjacent at least a portion of at least one of said sidewalls to define a soft-touch area on said armrest.

14. The component of a door trim panel assembly as set forth in claim 11 wherein said structural element defines a substrate having a bolster area.

15. The component of a door trim panel assembly as set forth in claim 14 wherein said soft-touch area is bonded to and formed adjacent at least a portion of said bolster area that is visible from the interior of a vehicle.

16. The component of a door trim panel assembly as set forth in claim 11 wherein said soft-touch area includes a different color than said structural element.
